(19) United States
(12) Patent Application Publication
(10) Pub. No.: US 2023/0196489 A1
(43) Pub. Date: Jun. 22, 2023

(54) Mission Critical Neighborhood Safety & Security System using Artificial Intelligence, Sensors, Robotics & Telecommunication

(71) Applicant: Prathamesh Khedekar, Downers Grove, IL (US)

(72) Inventor: Prathamesh Khedekar, Downers Grove, IL (US)

(21) Appl. No.: 17/553,816

(22) Filed: Dec. 17, 2021

(51) Int. Cl. G06Q 50/26; G08B 25/00; G08B 21/02; F21V 23/04; F21S 8/08; G05D 1/02; G05D 1/00; G06V 20/52; G06V 20/62; G01S 17/89; G06N 3/02

(52) U.S. Cl. CPC G06Q 50/265; G08B 25/009; G08B 21/02; F21V 23/0478; F21S 8/085; G05D 1/0214; G05D 1/0255; G05D 1/0088; G06V 20/52; G06V 20/625; G01S 17/89; G06N 3/02; G05D 2201/0209; G06V 2201/08

(57) ABSTRACT

The present invention discloses an advanced process of dealing with emergency situations through an intelligent methodology. The proposed invention can be used by all people to get help and support in a very short time. The Mission Critical Neighborhood Safety and Security System is enabled by artificial intelligence, autonomous robots, mission critical telecom network, and sensors. This system aims to provide neighborhood safety and security service to residents by using autonomous robots that are deployed in each neighborhood. These robots work closely with the mission critical module mounted on light poles and detect anomalies like car accidents, kidnapping, fire, smoke, thefts, gunshots, street fights, etc. The mission critical device mounted on the light pole captures this information and sends this information along with notification to public safety agencies (police, paramedics, firefighters). The public safety agents can then communicate with the victims onsite as well as residents through these robots and thus safeguard neighborhoods. In addition to this, the mission critical device mounted on the light pole is also equipped with acoustic sensors, thermal sensors, high-definition cameras, and air quality monitoring sensors. This information is also relayed to the residents and the public safety agencies. In order to ensure higher reliability, this system uses a mission critical public safety grade telecom network as the primary source of Internet and a WiFi mesh system as a backup source of Internet. This system is powered by electricity available through the light pole as well as solar modules mounted on each of the light poles.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates to security systems and more particularly relates to systems and methods that use Artificial intelligence-based object detection systems, robotics, LiDARs, and telecommunication data networks to provide mission critical public safety grade neighborhood safety and security service to residents and public safety agencies.

### Description of the Related Art

Home safety is a concern for many homeowners and renters. Those seeking to protect or monitor their homes may install one or more security cameras in or around their homes. Thus, in recent years, safety and security systems play a critical role in the United States. If not already in existence, these systems are likely to become widely used in other countries of the world. Several Western European countries already have security systems implemented at a massive scale. The number and variety of such devices also reflect that no single device has been found satisfactory enough to prevent or assist individuals in the case of an emergency.

There are many inventions that have been registered in prior art regarding security and emergency response system. For instance, a Danger warning and emergency response system and method bearing US patent U.S. Pat. No. 6,084,510A is issued to Lemelson; Jerome H., Pedersen; Robert D. The patent discloses a surveillance platforms in airborne craft (8,10), land-based vehicles (12), vessels at sea or fixed structures (14) detect dangers using conventional scanners and transmit information signals describing the dangers to a control center (2) which analyzes the data and determines the degree of danger and its geographic extent. The center generates a danger warning and emergency response, including a danger index. The warning/response message identifies the degree of danger (danger index 144) and the GPS coordinates (142) of the impacted geographic area for a wide region or regions of the earth (FIGS. 2-6). A vulnerability index (FIG. 16) determined using neural networks (FIGS. 13-14), and fuzzy logic (FIGS. 15-20) enables a prioritized warning/response. The center broadcasts (18) the danger warning and emergency response (FIG. 9) to a large population of remotely located warning devices (11), such as a network of pagers, each of which has a GPS receiver (6,28). The pagers compare the received danger coordinates with their own GPS coordinates, and each pager determines the extent to which it is in danger. The warning device automatically issues a warning signal or signals, which may be audible, visual, or vibratory, appropriate to the degree of danger. Emergency manned vehicles may also directly receive the broadcast warning/response and be immediately alerted to act appropriately relative to the degree of risk danger. One embodiment broadcasts (16) directly to home T.V.'s and radios (17), which have internal GPS receivers and which display/annunciate an emergency message customized to that receiver resulting from the internal comparison of the danger coordinates versus the local receiver coordinates.

A Real-time, crowd-sourced, geo-location-based system for enhancing personal safety bearing US patent 2,021,0067940A1 is issued to Marshalla Yadav. The disclosure describes a crowd-sourced social network and geo-location-based system for enhancing personal safety via users' mobile devices. The system shares information (including images, video, and/or audio) about crimes, fires, accidents, and public safety-related events and their geo-locations. Users selectively receive notifications for such events in a map view based on the events' proximity to users or on whether the notification was initiated by a person in the users' social network. The system also shares users' status and geo-location information with previously identified persons or with all persons in their social network to let them know their geo-location and/or when they have reached a destination. Through the system's operation, a user can initiate sending of a distress signal to pre-identified persons, groups within their social network, or others who are within a pre-established distance. Additionally, the system can send a distress signal if the user fails to check-in.

A safety and security system patent issued to Hoskinson John D, Horton Stephen W. The patent discloses a 911 emergency response system that includes a location identification module, preferably in solid state circuit form, associated with each residence or each extension of a PBX is disclosed. Preferably, the location identification modules are powered by telephone line voltage. A location identification module is enabled when its associated telephone goes off-hook and an emergency code, e.g., 911, is dialed. Thereafter, in response to an inquiry from the emergency response center that receives the emergency call, the location identification module sends the location of the associated telephone to the emergency response center operator, where the location is displayed on a dispatcher's console.

A safety and security mobile application bearing U.S. Pat. No. 8,538,374B1 is issued to Myflare Safety Services LLC. The patent relates to an automated system, method, or computer program product for providing emergency communications can include an emergency communications application and a MyFlare emergency communications server. The MyFlare emergency communications application can run on a mobile device and can be configured to, when activated, interface with the MyFlare emergency communications server to send preconfigured emergency messages to a preconfigured set of emergency contacts. Different emergency profiles can be preconfigured for which different emergency messages can be sent. Additionally, a different set of emergency contacts can be assigned for different emergency profiles. The emergency communications application can be configured to capture additional information, such as but not limited to GPS location of the device, photo, video, or sound recording, in preconfigured time intervals. The updated information can be sent to one or more preconfigured emergency contacts as part of the initial emergency message or a subsequent emergency notification update.

A Personal emergency response communications system is a U.S. Pat. No. 5,305,370A issued to Lloyd Kearns, Petersen David E. The patent discusses a personal emergency response system in which a handheld portable transmitter (12) activates a base unit (14) interfaced with the telephone network (16) to dial 9-1-1 and permit direct communications with the operator (18) at the public safety answering point even though the user (10) is unable to reach a telephone (36). The transmitter (12) activates the base unit (14) as well as optional remote units (48) located throughout the user's residence or place of business. The base unit (14) and remote units (48) include speaker-phone communication capabilities that permit two-way communications between the user (10) and the 9-1-1 system operator (18).

A U.S. Pat. No. 7,395,151B2 is a System and method for safety and security issued to O'neill Dennis M, Guillermo Francisco Arango. The system discloses a knowledge-based system and method for establishing and managing routes for emergency vehicles. The knowledge-based system and method uses a knowledge base having information useful in establishing and managing routes for emergency vehicles, including information on intersections, road segments connecting intersections, expected travel time along the road segments, and dynamic factors that influence traffic flow, and a database for storing routes designed using the information useful in establishing and managing routes. The knowledge-based system also consists of one or more software modules operable to retrieve information from the knowledge base and to perform operations such as designing routes between locations involved in emergency response, selecting between such routes, and modifying such routes, all using the information stored in the knowledge base.

A U.S. Pat. No. 8,866,606B1 elaborates systems and methods for automated personal emergency responses, and it's issued to Rockwilli RMR LLC. The patent discloses a subscriber device for use in an automated personal emergency response system implemented as a conference bridge on a remote computing network. The device, intended to be worn as a pendant, wristband, or in another wearable configuration, includes a high-resolution color display for signaling a user of the subscriber device with notifications, arrows for directional guidance, and/or other status messages. The device also includes microphones and speakers for enabling a teleconference between a user of the subscriber device in need of assistance and parties joined to the teleconference via the automated personal emergency response system. The user of the subscriber device may initiate the call for assistance and teleconference via a press of a single button on the device; alternatively, accelerometers in the device may detect a fall and automatically initiate the call. The device can receive medical telemetry and provide it to conference participants and perform home automation tasks.

There are multiple solutions that have been presented in the prior art. However, these solutions are limited and restricted to their conventional systems. It has to be noted that the current invention proposes an advancement in providing an advanced safety and security system. A safety system is presented in the form of a Neighborhood Safety and Security System using Artificial Intelligence, Sensors, Robotics, and Telecommunication to provide support during any type of emergency events like criminal activities, physical abuse, sexual abuse, robbery/shoplifting, arson, flooding, drowning, fall detection, speeding cars, car accident, health emergency, road rage, street fights etc.

None of the previous inventions and patents, taken either singly or in combination, is seen to describe the instant invention as claimed. Hence, the inventor of the present invention proposes to resolve and surmount existent technical difficulties to eliminate the aforementioned shortcomings of the prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of Neighborhood Safety and Security System using Artificial Intelligence, Sensors, Robotics, and Telecommunication.

It is also the primary objective of the invention to provide systems and methods that use Artificial intelligence-based object detection systems, robotics, LiDARs, and telecommunication data networks to provide mission critical public safety grade neighborhood safety and security service to residents and public safety agencies.

It is another objective of the invention to provide smart Mission critical autonomous public safety robots that can be deployed in each neighborhood to provide safety and security services to pedestrians and residents.

It is also the objective of the invention to provide Cameras and mini computers equipped with object detection systems that can be mounted on the light poles in the city to classify different types of objects on the streets and sidewalks, including but not limited to people, vehicles, harmful equipment.

The most crucial objective of the invention is that on detecting any incident on the video stream, an emergency message will be generated, and respective authorities/individuals will be alerted.

It is further the objective of the invention to provide LiDARs, which can be mounted on the same pole to capture the speed of vehicles.

It is also the objective of the invention to provide Environmental sensors that can monitor temperature, pressure, CO2 levels and that can be mounted on the same pole to assess the quality of the air.

A further object is to provide an assembly that is convenient and easy to use.

Still, yet another object of the present invention is to provide a new and improved security system which provides in the apparatuses and methods of the prior art some of the advantages thereof, while simultaneously overcoming some of the disadvantages commonly associated therewith.

Other aspects, advantages, and novel features of the present invention will become apparent from the detailed description of the invention when considered in conjunction with the accompanying drawings.

This summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification and serve to further illustrate embodiments of concepts that include the claimed invention, and explain various principles and advantages of those embodiments.

FIG. 1 shows the process view of mission critical response system as per preferred embodiments of the invention.

FIG. 2 shows the mission critical networking components as per preferred embodiments of the invention.

FIG. 3 shows the mission critical safety device/light pole architecture as per preferred embodiments of the invention.

FIG. 4 shows the mission critical system components as per preferred embodiments of the invention.

FIG. 5 shows mission critical anomaly detection as per preferred embodiments of the invention.

FIG. 6 shows mission critical robot operation flow as per preferred embodiments of the invention.

FIG. 7 shows mission critical pedestrian safety scenario operation flow as per preferred embodiments of the invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting but rather as a basis for the claims and as a representative basis for teaching one skilled in the art to employ the present invention in virtually any appropriately detailed system, structure, or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to an advanced system and method that uses Artificial intelligence-based object detection systems, robotics, LiDARs, and telecommunication data networks to provide mission critical public safety grade neighborhood safety and security service to residents and public safety agencies.

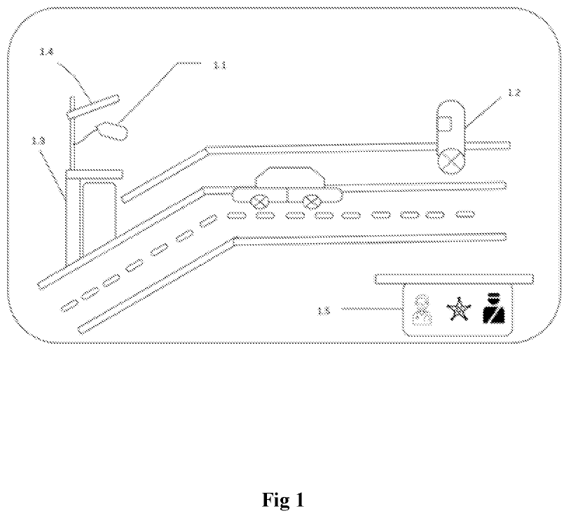

The mission critical safety and security system, as illustrated in FIG. 1, works under multiple components, including but not limited to Autonomous neighborhood safety and security robot, neighborhood safety and security devices equipped with a camera, computer enabled with artificial intelligence (AI), LiDAR and 4G router functionalities. It further includes the usage of street lights and poles to provide autonomous robot shelter and the installation of autonomous safety and security devices. The process will also include the role of local emergency services offices as critical support to make this system successful. The numbering on the drawing shows the following:
1.1—Neighborhood Safety & Security Device equipped with Camera, Artificial intelligence-enabled computer, LiDAR, 4G LTE telecom router
1.2—Autonomous Neighborhood Safety & Security Robot
1.3—Autonomous Robot Shelter
1.4—Street Light
1.5—Local Emergency Services Office

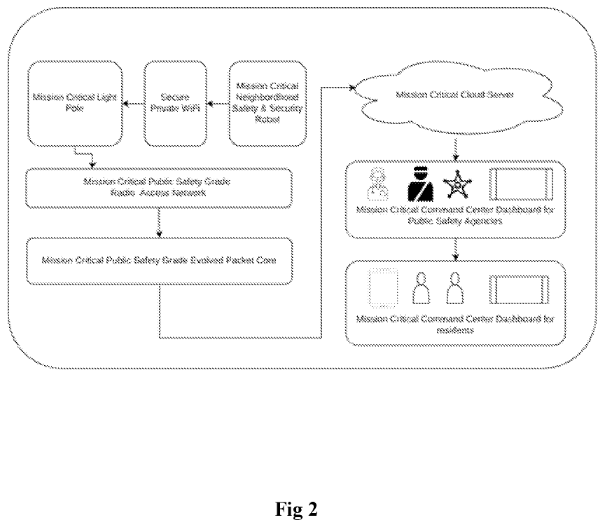

FIG. 2 depicts the mission critical networking components where mission critical neighborhood safety and security system robots will connect over a secure private WiFi connection with the nearby mission critical light pole. The information received from mission critical neighborhood safety and security robot will be processed by the mission critical light pole and will be transmitted to the mission critical cloud server via the mission critical public safety grade radio access network and the mission critical public safety grade evolved packet core network. The mission critical cloud server will provide mission critical command center dashboard for public safety agencies and for residents, as illustrated in FIG. 2.

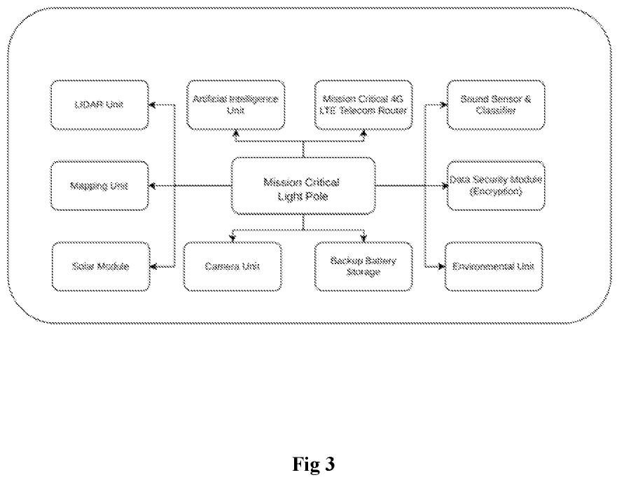

The mission critical safety device/light pole architecture, as shown in FIG. 3, involves the LIDAR unit, mapping unit, solar module, artificial intelligence (AI) unit, mission critical 4G LTE telecom router, sound sensor and classifier, data security module, environmental unit, backup battery storage, and camera unit.

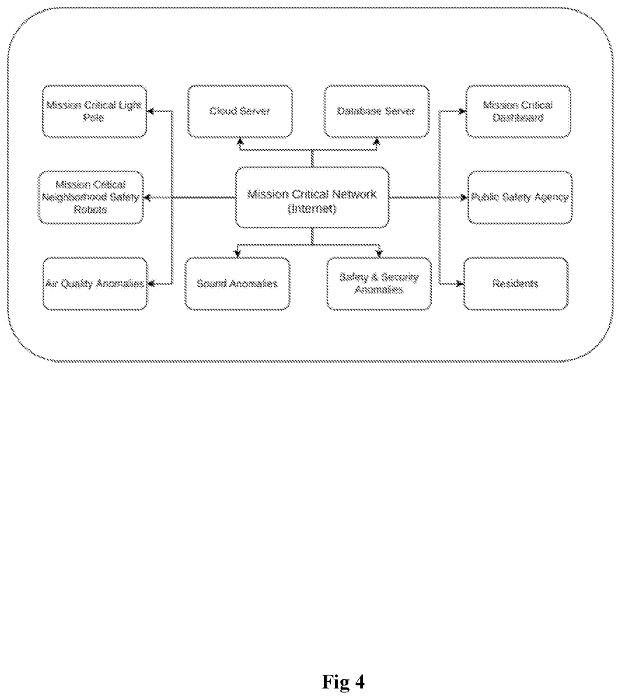

The mission critical system as shown in FIG. 4, involves mission critical light pole, mission critical neighborhood safety robots, air quality anomalies, sound anomalies, cloud server, database server, mission critical dashboard, public safety agencies, residents, and safety and security anomalies.

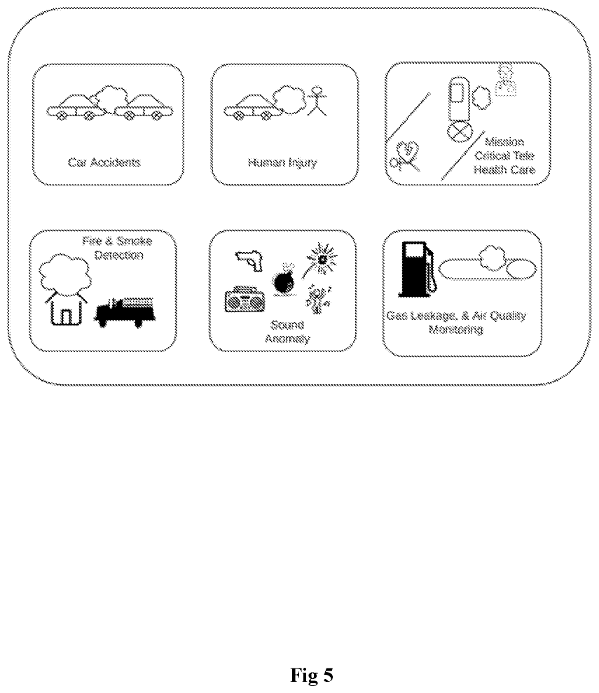

The mission critical anomaly detection system can detect different types of safety and security anomalies involves as shown in FIG. 5, including but not limited to car accidents, human injury, fire and smoke detection, sound anomaly classification, gas leakage, and air quality monitoring. In addition to this, the mission critical anomaly detection system on detecting injured pedestrians can trigger the telehealth service to provide real-time feeds of the pedestrian to the doctor and thus initiate an emergency response.

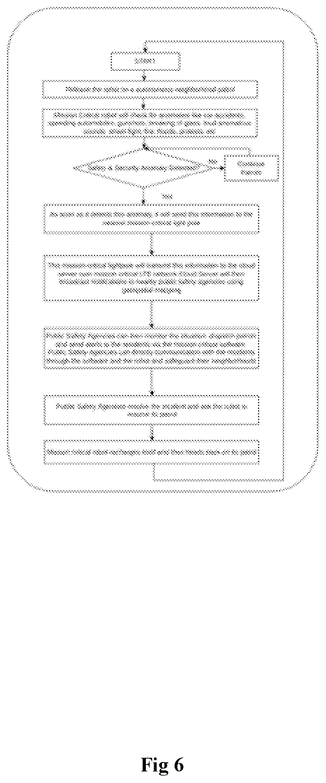

The mission critical operation, as shown in FIG. 6, will include the process of releasing the robot on an autonomous neighborhood patrol. The robot will check for anomalies, including but not limited to car accidents, speeding automobiles, gunshots, breaking of glass, sounds, street fights, fire, etc. If there is no security anomaly detected, then the patrol will continue. However, if any threatening condition is detected, the information will be sent to the nearest mission critical pole. The mission critical light pole will transmit this information to the cloud-based server over mission critical network. The mission critical cloud server will then broadcast notifications to the nearest public safety agencies using geospatial mapping. The agencies can then plan to take their actions and send alerts to residents of the area through mission critical software. Once the mission is completed, the robots will be notified through software, and then the usual operation will be resumed. The mission critical robot recharges itself and then heads backs to its standard patrolling process.

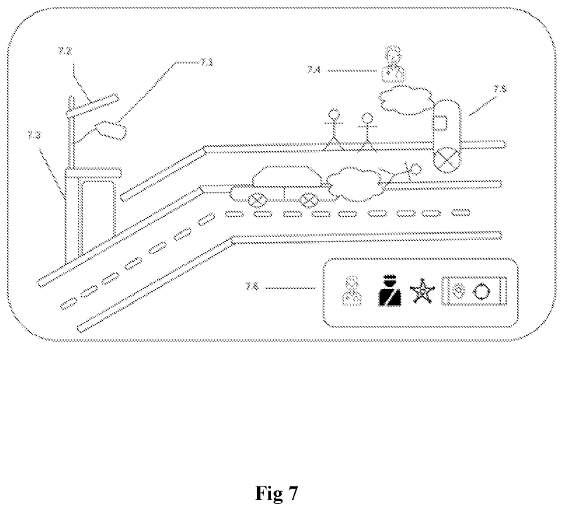

The FIG. 7 shows mission critical pedestrian safety scenario where incase of any incident related to pedestrian or car accident, the mission critical autonomous safety robot can send an alert to public safety agencies and initiate an emergency response. In addition to this, the public safety agencies can use the live feeds transmitted by the robot via the mission critical dashboard to provide telehealth service to the injured pedestrian. The numbering on the drawing shows the following:
7.1—Mission Critical Neighborhood Safety & Security Device
7.2—Mission Critical Light Pole
7.3—Autonomous Robot Shelter
7.4—Mission Critical Telehealth Service
7.5—Mission Critical Autonomous Neighborhood Safety Robot
7.6—Mission Critical Command Center Dashboard for Public Safety Agencies

The Autonomous neighborhood safety robots will be deployed in each neighborhood that raises safety/security concerns. These robots will patrol the neighborhoods at night using the sidewalk. These robots will be equipped with a sound sensor and artificial intelligence (AI) module. The artificial intelligence (AI) module will serve as the eye of the robot and will enable the robot to detect neighborhood safety anomalies. These anomalies include people carrying weapons, cars driving at higher speeds, loud sounds eliminated from either vehicles, homes, or streets. The sound module on the robot will further classify these sounds as broken glass, woodcutting, carjacking, gunshot, people, fighting, etc. As soon as an anomaly is detected by the robot, this information will be shared with the local public safety agency. Thus, the robots will provide situational awareness to the county/city officers. These robots will periodically patrol the neighborhood and recharge themselves using the robot shelter located under the nearby electric pole.

In an embodiment, the assembly presents a camera agnostic surveillance system coupled with artificial intelligence (AI) units, mapping, and LIDAR unit and other components to analyze on a real-time basis and can sends alerts for emergency events like criminal activities, physical abuse, sexual abuse, robbery/shoplifting, arson, flooding, drowning, fall detection, mental issues detection, etc. It provides the exact GPS coordinates in all locations. Furthermore, it requires no/minimal input by the user. The proposed methodology is affordable and proposed to be significantly less expensive than individual personal emergency response systems.

Each light pole, as per its further embodiment's is artificial intelligence (AI) enabled and will be equipped with a solar module, robot shelter, environmental sensors, network equipment, high-definition cameras, LiDAR, sound sensor, and artificial intelligence (AI) module. Robot shelter will allow the robots to recharge at the end of each patrol and thus enable perennial neighborhood safety and security patrols for the robots. A solar module will be used to ensure a backup source of power, i.e., the battery is continuously charged to provide a high degree of reliability. Network equipment will house 4G LTE (Fourth Generation Long-Term Evolution) modems that will allow the smart pole to transmit information back to the neighborhood safety portal. High-definition cameras will continuously analyze the street and sidewalk traffic for anomalies. Artificial Intelligence (AI) module will use these feeds generated by the camera and will leverage object detection frameworks like YOLOv5 to detect the specifics of an anomaly, i.e., car license plate, car model and color, suspect information, etc. The sound sensor will be used to detect anomalies such as car accidents, breaking of glass, gunshots, fireworks, illegal broadcasting of sound that can impact the safety and security realm of the neighborhood. LiDARs will be used to monitor the speed of the car.

High-definition cameras, as per its additional embodiments, will be deployed on the light pole will capture the incoming and outgoing traffic through a given lane. The LiDAR feed will be used to detect the speed of each vehicle, and the artificial intelligence (AI) module will extract the license number, make, and model of the vehicle. If, at any point the speed is higher than the safe speed listed for that neighborhood, the artificial intelligence (AI) module will capture the evidence and will share it with the public safety agency and the residents. The public safety agency can then use this information to take appropriate action against the corresponding driver and thus provide safety and security service in the neighborhood.

The smart poles, as per its further embodiments, will also house the sound sensor. The sound sensor will use a directional microphone to capture sound waves dissipating through each lane on the street. These sound waves will be analyzed using a neural network and will be classified as different types of anomalies such as gunshots, breaking of glass, accidents, people screaming for help, emergency, etc. This information, once captured, will be delivered to the local public safety agency over a reliable public safety mission critical 4G LTE network. While the paramedics are on their way, they can dispatch the robot deployed in this neighborhood to the appropriate spot using remote navigation capabilities and collect real-time information. They can also engage with the people on site through real-time video-chat service.

Furthermore, to ensure high reliability and availability, this system will use a mission critical public safety 4G LTE network that operates in FCC band 14. This will ensure all the data traffic traversing this system is served with the highest priority and reliability. Thus, in case of major public events like sports, protests, natural calamity, the data traffic of this system will be served with the highest priority (QoS) and over a dedicated long-term evolution access point name (LTE APN) profile. The Artificial Intelligence-enabled Light Poles functionality further includes Active Environment Monitoring. Each of these poles will be equipped with an air quality monitoring sensor. These sensors will continuously monitor the content of CO2, O2, Nitrogen, smoke, radioactive elements in the neighborhood. The information captured through this module will be displayed on a geographic map and will be provided to the local public safety agency and the residents over a software application. This information will allow the public safety agencies to ensure the residents are aware of the quality of the air, and it will also allow them to guide the residents through these adverse conditions.

The Artificial Intelligence-enabled Light Poles, in addition to the public safety grade 4G LTE network, this system will also use a Mesh WiFi network as a backup source of the Internet to provide data transmission functionality. If at any point the public safety grade 4G LTE network goes down, Mesh WiFi network deployed by local municipalities and Internet Service Providers (ISPs) can be used to provide data transmission functionality. Thus, this also improves the reliability and availability of this system, making it resilient to network outages.

The Artificial Intelligence-enabled Light Poles will also provide data encryption where the data at rest and the data in transit will be fully encrypted, making it difficult for hackers to modify the data. Data in transit will be encrypted using Transport Layer Security (TLS)/Secure Sockets Layer (SSL) encryption protocol with 256-bit keys. Data at rest will be encrypted using an on-chip encryption module.

As per its further embodiments, an associated software application will be made available to local public safety agencies and residents. Residents will use this software to receive safety and security information on a daily basis for their neighborhood. Statistics related to car accidents, gunshots, fights, speeding cars, air quality, crime will be made available to the residents.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

I: A Mission critical neighborhood safety and security system enabled by artificial intelligence, autonomous robots, mission critical telecom network, and sensors to alarm, transmit, and receive safety and security information on a daily basis for any neighborhood.

II: An artificially intelligent safety and security system where:
according to claim II, includes the process of releasing robot on an autonomous neighborhood patrol;
according to claim II, the robot will check for anomalies including but not limited to car accidents, speeding automobiles, gunshots, breaking of glass, sounds, street fights, fire, etc.;
according to claim II, if there is no security anomaly detected, then the patrol will continue;
according to claim II, if any threatening condition detected, the information will be sent to the nearest mission critical pole;
according to claim II, the mission critical light pole will transmit information to the cloud-based server over mission critical network;
according to claim II, the mission critical cloud server will broadcast notifications to nearest public safety agencies using geospatial mapping;
according to claim II, where the agencies can then plan to take their actions and send alerts to residents of the area through mission critical software;
according to claim II, once the mission is completed, the robots will be notified through software, and then the usual operation will be resumed, and,
according to claim II, the mission critical robot recharges itself and then heads back to its usual patrolling process.

III: A system and procedure of safety and security system where Autonomous neighborhood safety robots will be used for:
according to claim III, the Neighborhood Autonomous Safety Patrols to safeguard the neighborhoods;
according to claim III, the Neighborhood Autonomous Safety Robots will use artificial intelligence (AI) module to detect neighborhood anomalies, including people carrying weapons, cars driving at higher speeds, loud sounds eliminated from either vehicles, homes, or streets;
according to claim III, the Neighborhood Autonomous Safety Robots will periodically patrol the neighborhood and recharge themselves using the robot shelter located under the nearby electric pole and,
according to claim III, the Neighborhood Autonomous Safety Robots will share safety information with the local public safety agency, and the robots will also provide situational awareness to the county/city officers.

IV: A system and procedure of safety and security system where (AI) artificial intelligence-enabled Light Poles will be deployed comprising:
according to claim IV, where each light pole in the neighborhood will be equipped with a solar module, robot shelter, environmental sensors, network equipment, high-definition cameras, LiDAR, sound sensor, and an artificial intelligence (AI) module;
according to claim IV, where Robot shelter will allow the robots to recharge at the end of each patrol
according to claim IV, where Network equipment will house mission critical public safety grade 4G LTE modems that will allow the smart pole to transmit information back to the neighborhood safety portal;
according to claim IV, where high-definition cameras will continuously analyze the street and sidewalk traffic for anomalies;
according to claim IV, where the sound sensor will be used to detect anomalies such as car accidents, breaking of glass, gunshots, fireworks, illegal broadcasting of sound that can impact the safety and security realm of the neighborhood. LiDARs will be used to monitor the speed of the car.
according to claim IV, A system and procedure of safety and security system where (AI) artificial intelligence-enabled Light Poles will provide High-Speed Detection (HSD) functionality and LiDAR feed will be used to detect the speed of each vehicle, and the artificial intelligence (AI) module will extract the license number, make, and model of the vehicle.
according to claim IV, A system and procedure of safety and security system where (AI) artificial intelligence-enabled Light Poles will provide Sound Anomaly Detection functionality and sound waves will be analyzed using a neural network and will be classified as different types of anomalies such as gunshots, breaking of glass, accidents, people screaming for help, emergency, etc. This information, once captured, will be delivered to the local public safety agency over a reliable public safety mission critical 4G LTE network.
according to claim IV. A system and procedure of safety and security system where the system will use a mission critical public safety 4G LTE network that operates in FCC band 14 to ensure all the data traffic traversing the system is served with the highest priority and reliability.
according to claim IV, A system and procedure of safety and security system where (AI) artificial intelligence-enabled Light Poles will perform Active Environment Monitoring with an air quality monitoring sensor.
according to claim IV, A system and procedure of safety and security system where (AI) artificial intelligence-enabled Light Poles will, in addition to public safety grade 4G LTE network, will also use a Mesh WiFi network as a backup source of the Internet to provide data transmission functionality.
according to claim IV, A system and procedure of safety and security system where data in transit will be fully encrypted, making it difficult for hackers to modify the data. Data in transit will be encrypted using Transport Layer Security (TLS)/Secure Sockets Layer (SSL) protocol encryption with 256-bit keys, and data at rest will be encrypted using an on-chip encryption module.
according to claim IV, A system and procedure of safety and security system where an associated software application will be used to update the residents regarding safety information through news, articles and statistics.
